(19) United States
(12) Patent Application Publication
(10) Pub. No.: US 2026/0366881 A1
(43) Pub. Date: Nov. 19, 2026

(54) METHODS AND SYSTEMS FOR AUTONOMOUS CONVOY ROUTING AND ROUTE MANAGEMENT

(71) Applicant: D3 DYNASTY HOLDINGS INC., LEWES, DE (US)

(72) Inventor: DENZELL MICHAEL BROWN, LEWES, DE (US)

(21) Appl. No.: 19/348,363

(22) Filed: Oct. 2, 2025

Related U.S. Application Data
(60) Provisional application No. 63/807,899, filed on May 19, 2025.

(51) Int. Cl. G01C 21/34; G08G 1/00; H04W 12/069; H04W 4/46

(52) U.S. Cl. CPC G01C 21/3415; G08G 1/22; H04W 12/069; H04W 4/46

(57) ABSTRACT

The present disclosure discloses a method and a system for autonomous convoy routing and route management. The method performed by the system includes authenticating a plurality of vehicles within a convoy based, at least in part, on an encrypted vehicle identifier associated with each vehicle of the plurality of vehicles. The method includes, upon successful authentication, allocating configuration data to the plurality of vehicles. The method includes determining at least one navigation route for each of the plurality of vehicles based, at least in part, on a plurality of navigation parameters. The method includes enabling communication between the plurality of vehicles via a Vehicle-to-Vehicle (V2V) communication network to exchange the determined navigation route. Herein, each of the plurality of vehicles is configured to traverse based on the determined navigation route.

### TECHNICAL FIELD

The present disclosure relates generally to vehicle fleet management and more particularly relates to methods and systems for secure, autonomous convoy coordination and route management across public, private, and tactical network environments. The present disclosure discloses methods and systems for autonomous convoy routing and route management.

### BACKGROUND

Convoy coordination systems are essential in various operational contexts, including military logistics, emergency disaster response, commercial freight transport, and autonomous fleet operations. The convoy coordination systems are responsible for managing the movement of multiple vehicles along designated routes, often under complex and dynamic conditions. With the increasing integration of autonomous and semi-autonomous vehicles into both military and civilian transportation infrastructures, there is a growing demand for secure, intelligent, and adaptive routing and control technologies capable of maintaining operational continuity in both standard and degraded environments.

Existing convoy coordination systems rely heavily on centralized control frameworks and manual input from human operators to determine routing, issue commands, and adapt to changing conditions. This reliance introduces several vulnerabilities, including vulnerability to communication breakdowns, delayed response times, and increased risk of human error. In critical scenarios such as battlefield operations, disaster zone logistics, or high-density freight routing, these vulnerabilities can compromise mission success, endanger personnel, and disrupt supply chains. Furthermore, commercial fleet operations increasingly face pressure to reduce emissions, comply with evolving regulations, and dynamically optimize delivery routes, all of which require real-time coordination capabilities that exceed the limitations of existing systems.

Existing convoy coordination technologies or methods often employ fixed routing logic and unencrypted communication protocols, offering limited support for autonomous decision-making or decentralized control. The existing convoy coordination systems lack vehicle-level authentication, secure command transmission, and resilient failover mechanisms such as emergency override capabilities. As a result, such systems are highly vulnerable to cyber threats, unauthorized access, and communication disruptions. Moreover, these systems are typically not interoperable across mixed network environments, such as public infrastructure, private transport networks, and tactical communication channels. This lack of interoperability and adaptability restricts their deployment in environments requiring seamless transition between different operational domains and levels of vehicle autonomy.

Therefore, there is a need for a secure and intelligent convoy coordination system that addresses the aforementioned deficiencies of existing technologies or methods. Such system needs to provide vehicle authentication, and include emergency override capabilities.

### SUMMARY

Various embodiments of the present disclosure disclose methods and systems for autonomous convoy routing and route management.

In an embodiment, a computer-implemented method is disclosed. The computer-implemented method performed by a system includes authenticating a plurality of vehicles within a convoy based, at least in part, on an encrypted vehicle identifier associated with each vehicle of the plurality of vehicles. Further, the computer-implemented method includes allocating configuration data to the plurality of vehicles in response to successful authentication. Herein, the configuration data includes at least a plurality of role assignments, a set of routing parameters, and an autonomy level for each vehicle. The computer-implemented method includes determining at least one navigation route for each of the plurality of vehicles based, at least in part, on a plurality of navigation parameters. Furthermore, the computer-implemented method includes enabling communication between the plurality of vehicles via a Vehicle-to-Vehicle (V2V) communication network to exchange the determined navigation route. Herein, each of the plurality of vehicles is configured to traverse based on the determined navigation route.

In another embodiment, a system is disclosed. The system includes a memory unit including machine-readable instructions. The system also includes a processor operably connected to the memory unit. The processor is configured to execute the machine-readable instructions to cause the system, at least in part, to authenticate a plurality of vehicles within a convoy based, at least in part, on an encrypted vehicle identifier associated with each vehicle of the plurality of vehicles. Further, upon successful authentication, the system is caused to allocate configuration data to the plurality of vehicles. Herein, the configuration data includes at least a plurality of role assignments, a set of routing parameters, and an autonomy level for each vehicle. The system is further caused to determine at least one navigation route for each of the plurality of vehicles based, at least in part, on a plurality of navigation parameters. The system is further caused to enable communication between the plurality of vehicles via a Vehicle-to-Vehicle (V2V) communication network to exchange the determined navigation route. Herein, each of the plurality of vehicles is configured to traverse based on the determined navigation route.

In yet another embodiment, a non-transitory computer-readable storage medium is disclosed. The non-transitory computer-readable storage medium includes computer-executable instructions that, when executed by at least a processor of a system, cause the system to perform a method. The method includes authenticating a plurality of vehicles within a convoy based, at least in part, on an encrypted vehicle identifier associated with each vehicle of the plurality of vehicles. The method further includes allocating configuration data to the plurality of vehicles in response to successful authentication. Herein, the configuration data includes at least a plurality of role assignments, a set of routing parameters, and an autonomy level for each vehicle. The method further includes determining at least one navigation route for each of the plurality of vehicles based, at least in part, on a plurality of navigation parameters. The method further includes enablingcommunication between the plurality of vehicles via a Vehicle-to-Vehicle (V2V) communication network to exchange the determined navigation route. Herein, each of the plurality of vehicles is configured to traverse based on the determined navigation route.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The following detailed description of illustrative embodiments is better understood when read in conjunction with the appended drawings. For the purposes of illustrating the present disclosure, exemplary constructions of the disclosure are shown in the drawings. However, the present disclosure is not limited to a specific device, or a tool and instrumentalities disclosed herein. Moreover, those in the art will understand that the drawings are not to scale. Wherever possible, like elements have been indicated by identical numbers:

FIG. 1 illustrates an example representation of a system architecture of a convoy coordination environment for civilian and military applications, in accordance with an embodiment of the present disclosure;

FIG. 2 illustrates a simplified block diagram of a system, in accordance with an embodiment of the present disclosure;

FIG. 3 illustrates a flow diagram representing routing decision logic performed by a routing module within the system architecture, in accordance with an embodiment of the present disclosure;

FIG. 4 illustrates an encrypted override communication process between a convoy vehicle and a remote computing system, in accordance with an embodiment of the present disclosure;

FIG. 5 illustrates an architecture of a convoy coordination system with inter-vehicle communication and obstacle detection,in accordance with an embodiment of the present disclosure;

FIG. 6 illustrates a process flow diagram depicting a method for autonomous convoy routing and route management, in accordance with an embodiment of the present disclosure;and

FIG. 7 is a simplified block diagram of an electronic device, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as not to unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features.

The term “vehicle” as used throughout the description generally refers to any land-based mobile unit participating in the convoy coordination system. The vehicle include, but is not limited to, manned or unmanned ground vehicles such as military transports, emergency service vehicles, commercial trucks, autonomous delivery units, or civilian automobiles. Vehicles can be equipped with onboard computing, navigation, and communication interfaces that enable participation in autonomous or semi-autonomous convoy operations.

The term “routing module” refers to a software and/or hardware component responsible for computing one or more navigation routes for vehicles in the convoy system. The routing module evaluates terrain data, mission parameters, and risk factors (such as threat likelihood or terrain difficulty) to rank and select optimal paths. It may also update routes dynamically in response to emergency events or override commands.

The term “remote computing system” refers to a centralized or distributed processing node that communicates with convoy vehicles over secure channels. The remote computing system performs mission oversight functions including issuing override commands, broadcasting updates, monitoring vehicle telemetry, and enforcing mission policies. The remote computing systemcan reside in a command center or cloud-based infrastructure.

### Overview

Various embodiments of the present disclosure provide methods, systems, electronic devices, and computer program products for autonomous convoy routing and route management. In various embodiments, the present disclosure describes a system for autonomous convoy routing and route management.

The system includes a processor and a memory. In an embodiment, the system is configured to authenticate a plurality of vehicles within a convoy based, at least in part, on an encrypted vehicle identifier associated with each vehicle of the plurality of vehicles. Further, upon successful authentication, the system is configured to allocate configuration data to the plurality of vehicles. Herein, the configuration data includes at least a plurality of role assignments, a set of routing parameters, and an autonomy level for each vehicle. Further, the system is configured to determine at least one navigation route for each of the plurality of vehicles based, at least in part, on a plurality of navigation parameters. Further, the system is configured to enable communication between the plurality of vehicles via a Vehicle-to-Vehicle (V2V) communication network to exchange the determined navigation route. Herein, each of the plurality of vehicles is configured to traverse based on the determined navigation route.

In an embodiment, the system is configured to receive an override command associated with at least one vehicle among the plurality of vehicles from a remote computing system via the V2V communication network. Further, the system is configured to determine whether the override command is to be executed by the at least one of the plurality of vehicles based, at least in part, on one or more emergency events.

In an embodiment, in response to determining the override command to be executed, the system is configured to determine a modified navigation route for each of the plurality of vehicles based, at least in part, on the one or more emergency events. Further, the system is configured to transmit the modified navigation route to the remote computing system. Herein, the remote computing system broadcasts the modified navigation route to each of the plurality of vehicles, thereby enabling the plurality of vehicles to traverse based on the modified navigation route. Further, the system is configured to log the modified navigation route along with a timestamp and a hash of the override command or the modified navigation route.

In an embodiment, the system is configured to determine the one or more emergency events based, at least in part, on the navigation parameters, terrain data and sensory data collected from the plurality of vehicles.

In an embodiment, the system is configured to determine whether the autonomy level of each vehicle meets a minimum override execution threshold to execute the override command. Further, the system is configured to regulate operational parameters of each vehicle based, at least in part, on the autonomy level of the vehicle.

In an embodiment, to authenticate the plurality of vehicles, the system is configured to validate a digital certificate associated with each vehicle of the plurality of vehicles using cryptographic signature verification.

In an embodiment, in response to detecting the one or more emergency events, the system is configured to generate one or more route options based, at least in part, on the terrain data and predefined mission parameters. Further, the system is configured to analyze one or more risk factors associated with the terrain data. The risk factors include threat likelihood, terrain difficulty, and alignment with the predefined mission parameters. Further, the system is configured to rank the one or more route options based, at least in part, on the one or more risk factors.

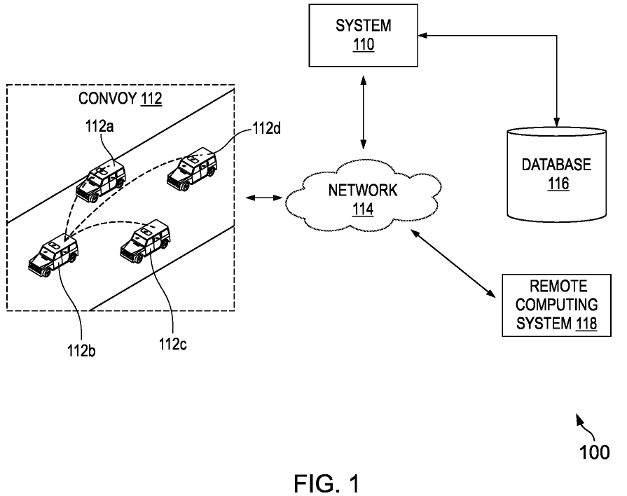

Various embodiments of the present disclosure are described hereinafter with reference to FIGS. 1-7.

FIG. 1 illustrate an example representation of a system architecture 100 of a convoy coordination environment for civilian and military applications, in accordance with an embodiment of the present disclosure. Although the system architecture 100 is presented in one arrangement, other arrangements are also possible where the parts of the architecture 100 (or other parts) are arranged or interconnected differently.

It is to be noted that, FIG. 1 presents one possible configuration, other configurations are also contemplated in which the components of the system architecture 100 (hereinafter also referred to as architecture 100) can be arranged or interconnected differently without departing from the scope of the disclosure. The architecture 100 includes a convoy coordination system 110 (hereinafter also referred to as a system 110), a convoy 112 of vehicles includinga plurality of vehicles such as 112a, 112b, 112c, and 112d (as shown in FIG. 1), a network 114, a database 116, and a remote computing system 118. In an embodiment, the remote computing system 118 act as a control authority or a remote command node.

The network 114 can include, without limitation, a Light Fidelity (Li-Fi) network, a Local Area Network (LAN), a Wide Area Network (WAN), a Metropolitan Area Network (MAN), a satellite network, the Internet, a fiber optic network, a coaxial cable network, an infrared (IR) network, a Radio Frequency (RF) network, a virtual network, and/or another suitable public and/or private network capable of supporting communication between any two entities/devices illustrated in FIG. 1. Furthermore, various entities in the architecture 100 may connect to the network 114 following various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, New Radio (NR) communication protocol, any future communication protocol, or any combination thereof. In some instances, the network 114 may utilize a secure protocol (e.g., Hypertext Transfer Protocol (HTTP), Secure Socket Lock (SSL), and/or any other protocol, or set of protocols for communicating with the various entities depicted in FIG. 1.

The network 114 enables secure, multi-directional communication between the plurality of vehicles 112a-112d, the system 110, the database 116, and the remote computing system 118. In an embodiment, the plurality of vehicles 112a-112d are equipped with mesh networking interfaces that allow peer-to-peer communication even when disconnected from centralized infrastructure such as the remote computing system 118. The network 114 supports protocols for both civilian and tactical environments, enabling flexible deployment across military, emergency, and commercial use cases.

The database 116 is communicably coupled with the system 110 and stores a variety of operational and mission-critical datasets. In other various examples, the database 116 includes, but is not limited to, configuration data, terrain data, vehicle-specific metadata, a plurality of navigation parameters, sensor calibration profiles, mission objectives, and security credentials. The database 116 can store encrypted mission data, terrain maps, vehicle profiles, certificate chains, validation policies, override command logs, and routing history. The system 110 retrieves and updates this data as part of the real-time convoy management.

The convoy coordination system 110 can be implemented in one or more computing devices (such as edge computing units, the remote computing system 118, or embedded vehicular modules) and is configured to perform autonomous or semi-autonomous route management and vehicle coordination. The system 110 include a variety of modules, such as an authentication module, a routing module, a communication module, and an execution module. These modules operate in conjunction to authenticate vehicles, allocate the configuration data and routing data, establish a vehicle-to-vehicle communication network, and handle override instructions from the remote computing system 118.

In a non-limiting implementation, the plurality of vehicles 112a–112d are authenticated using encrypted identification data, such as an encrypted vehicle identifier associated with each vehicle of the plurality of vehicles 112a–112d. It is to be noted that, each vehicle can include onboard sensors, computing units, and secure communication interfaces. The system 110, in conjunction with the remote computing system 118, authenticates each vehicle and dynamically allocates the configuration data, such as mission roles, routing parameters, autonomy levels, and control permissions. After successful authentication of the plurality of vehicles 112a-112d, the plurality of vehicles 112a-112d are then assigned a role within the convoy 112 and integrated into a coordinated mission operation.

The network 114 enables communication among the system 110, the plurality of vehicles 112a-112d in the convoy 112, the remote computing system 118, and the database 116. The network 114 may be implemented using a combination of communication protocols and topologies, including mesh networking, 5G/4G/LTE, tactical radio links, satellite links, Wireless Fidelity (Wi-Fi) direct, or other infrastructure-independent communication frameworks. In degraded or GPS-denied environments, the system 110 supports decentralized Vehicle-to-Vehicle (V2V) communication to preserve command integrity and mission continuity.

The remote control system 118 act asthe remote command node, a mission control system, or an authorized personnel node responsible for issuing authenticated override commands during mission-critical scenarios. In some embodiments, the system 100 operates in a decentralized mode, where routing and control decisions are distributed among the plurality of vehicles 112a-112d using a mesh communication protocol. Each vehicle out of the plurality of vehicles 112a-112d, based on its autonomy classification and allocated permissions, participates in route evaluation, obstacle detection, threat analysis, and propagation of updated navigation instructions. This approach ensures robust operation even in contested, disconnected, or infrastructure-compromised environments.

The number and arrangement of systems, devices, and/or networks shown in FIG. 1 are provided as an example. There may be other systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices.

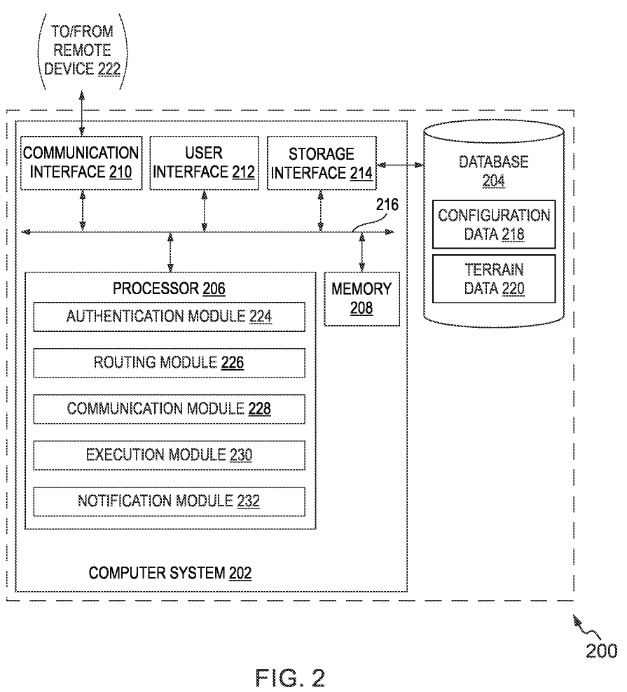

FIG. 2 illustrates a simplified block diagram of a system, in accordance with an embodiment of the present disclosure. The system 200 is identical to the system 110 of FIG. 1. In one embodiment, the system 200 is a part of the system architecture 100. In some embodiments, the system 200 is embodied as a cloud-based and/or SaaS-based (software as a service) architecture.

The system 200 includes a computer system 202 and a database 204. The computer system 202 includes at least one processor 206 for executing instructions, a memory 208, a communication interface 210, a user interface 212, and a storage interface 214 that communicate with each other via a bus 216. The database 204 includes configuration data 218 and terrain data 220. It is to be noted that, the database 204 is identical to the database 116 of FIG. 1.

In one non-limiting example, the database 204 includes, but is not limited to, configuration data 218, terrain data 220, vehicle-specific metadata (not shown in FIG. 2), the plurality of navigation parameters(not shown in FIG. 2), the set of routing parameters, sensor calibration profiles (not shown in FIG. 2), mission objectives (not shown in FIG. 2), and security credentials (not shown in FIG. 2). The configuration data 218 can define the convoy structure, vehicle roles (e.g., lead vehicle, support vehicles, scout, etc.), operational thresholds, autonomy levels, and communication permissions. In a non-limiting implementation, the configuration data 218 includes but not limited to, a plurality of role assignments, a set of routing parameters, and an autonomy level for each vehicle.

The term “configuration data” refers to a collection of predefined and dynamic parameters used to govern the behavior, coordination, and operational control of vehicles within a convoy system. The “autonomy level” refers to the degree of decision-making and operational independence granted to a vehicle within the convoy system.

The term ‘role assignments’ refers to the designation of specific operational functions or responsibilities to each vehicle within a convoy, based on predefined mission parameters, vehicle capabilities, and dynamic system requirements. Role assignments enable coordinated behavior among the vehicles and ensure that each unit performs tasks aligned with its physical characteristics, sensor suite, autonomy level, and mission priority. The plurality of role assignments can include, but are not limited to, lead vehicle, support vehicle, scout vehicle, rear guard (i.e., follow vehicle), relay node, and command vehicle, each designated based on the vehicle’s operational function, capabilities, and mission context. For example, lead vehicle sets the convoy’s path, controls speed, and acts as the primary navigation reference. For example, support vehicle carries critical cargo, equipment, or personnel, may provide logistical redundancy. For example, scout vehicle operates ahead of the convoy to assess terrain, detect obstacles, or identify threats. For example, rear guard maintains tail-end security, monitors for stragglers, and ensures convoy cohesion. For example, relay node acts as a mobile communication bridge to maintain Vehicle to Vehicle (V2V) or Vehicle-to-Everything (V2X) connectivity in low-signal environments. For example, command vehicle serves as a localized control node capable of dispatching reroute or override commands.

The term “routing parameters” refers to a set of operational and environmental criteria used by the system to calculate optimal navigation paths for each vehicle in the convoy. These parameters helps the routing module in selecting safe, efficient, and context-aware routes. The set of routing parameters can include but are not limited to, vehicle type and class, road conditions, traffic data, weather information, security threat levels, and time constraints.

For example, the routing parameters can define whether a heavy transport vehicle should avoid unpaved or narrow roads, whether high-threat zones should be bypassed during certain hours, or whether weather anomalies such as flooding or fog require adaptive rerouting. These routing parameters can also account for mission-critical requirements such as fuel efficiency, stealth movement, or coordination with external assets, ensuring that each route is aligned with both convoy objectives and external environmental conditions.

The term “terrain data” refers to geospatial, environmental, and topographic information relevant to the area of operation through which a convoy is intended to travel. Terrain data include, but is not limited to, elevation maps, road types and surface conditions, obstacle locations, threat zones, and information about environmental hazards such as floods, wildfires, or landslides. In an example, the terrain data can includeroad network graphs, elevation data, obstacles, and environmental overlays (e.g., weather conditions, flood zones, debris fields), and threat maps derived from external intelligence sources or onboard sensor fusion.

The term “navigation parameters” refers to a set of variables that represent a vehicle’s current state and surrounding environment, used to support autonomous or semi-autonomous routing and maneuvering. Navigation parameters can include, but are not limited to, current vehicle location, velocity, Global Positioning System (GPS) or alternative positioning data, and dynamic environmental feedback such as terrain risk scores, road surface conditions, visibility, and proximity to other objects or vehicles. The navigation parameters are continuously updated and utilized by the system 200 to inform route selection, vehicle coordination, collision avoidance, and mission compliance.

In some embodiments, the database 204 is integrated within the computer system 202. For example, the computer system 202 may include one or more hard disk drives as the database 204. The user interface 212 is an interface such as a Human Machine Interface (HMI) or a software application, that allows users such as an administrator, to interact with and control the system 200 or one or more parameters associated with the system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically, these components may correspond to icons, layout, color schemes, buttons, sliders, dropdown menus, tabs, links, error/success messages, mouse and touch interactions, keyboard shortcuts, tooltips, screen readers, and the like.

A storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a Redundant Array Of Independent Disks (RAID) controller, a Storage Area Network (SAN) adapter, a network adapter, and/or any component providing the processor 206 with access to the database 204.

The processor 206 includes suitable logic, circuitry, and/or interfaces to execute operations for determining degradation in the performance of the deployed machine learning model. Examples of the processor 206 include, but are not limited to, an Application-Specific Integrated Circuit (ASIC) processor, A Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing operations. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the system 200, as described herein. In another embodiment, the memory 208 may be realized in the form of a database server or a cloud storage working in conjunction with the system 200, without departing from the scope of the present disclosure.

The processor 206 is operatively coupled to the communication interface 210, such that the processor 206 is capable of communicating with a remote device 222, such as the remote computing system 118 or communicating with any entity connected to the network 114 (as shown in FIG. 1).

It is noted that the system 200 as illustrated and hereinafter described, is merely illustrative of an apparatus that could benefit from embodiments of the present disclosure and, therefore, should not be taken to limit the scope of the present disclosure. It is noted that the system 200 may include fewer or more components than those depicted in FIG. 2.

It should be noted that components described herein can be configured in a variety of ways, including electronic circuitry, digital arithmetic, logic blocks, and memory systems in combination with software, firmware, and embedded technologies. Moreover, it should also be noted that these components may be communicably coupled with each other to exchange information with each other for performing the one or more operations facilitated by the system 200. In one implementation, the processor 206 includes an authentication module 224, a routing module 226, a communication module 228, and an execution module 230. It should be noted that components, described herein, such as the authentication module 224, the routing module 226, the communication module 228, and the execution module 230 can be configured in a variety of ways, including electronic circuitries, digital arithmetic, and logic blocks, and memory systems in combination with software, firmware, and embedded technologies.

In an embodiment, the authentication module 224 is configured to authenticate the plurality of vehicles 112a-112d within the convoy 112 based, at least in part, on an encrypted vehicle identifier associated with each vehicle of the plurality of vehicles 112a-112d. In an implementation, to authenticate the plurality of vehicles, the authentication module 224 is configured tovalidate a digital certificate associated with each vehicle of the plurality of vehicles 112a-112d using cryptographic signature verification. It is to be noted that, each vehicle is embedded with an identifier (ID) (for example, cryptographically signed ID) and a tag (for example, scrollcommand-issued role tag such as Military (MIL), Emergency Services (EMS), Commercial (COMM), and Civilian (CIV)).

In an embodiment, upon successful authentication, the authentication module 224 is configured to allocate the configuration data 218 to the plurality of vehicles 112a-112d. Herein, the configuration data 218 includes at least the plurality of role assignments, the set of routing parameters, and the autonomy level for each vehicle.

For example, each vehicle in the convoy 112 may be provisioned with a scroll command-compliant X.509v3 digital certificate, signed by a fleet root authority (i.e. remote computing system 118) and stored in a Trusted Platform Module (TPM) or a Hardware Security Module (HSM) on board the vehicle. During initialization of the convoy mission, the authentication module 224 initiates a handshake process herein each vehicle broadcasts its signed identity packet over the network 114. The authentication module 224 verifies the origin, signature, expiration, and trust level associated with the certificate, thereby confirming that the vehicle is authorized for inclusion in the convoy 112 and is operating within the defined mission geofence or trust region. Upon successful authentication, the authentication module 224 allocates the configuration data 218 to each vehicle, including role assignments (e.g., lead vehicle, scout, and relay node), routing parameters (e.g., terrain risk threshold, geofence scope, and override latency class), and autonomy levels (e.g., full-autonomy for lead vehicle, and override-restricted mode for civilian vehicle). The configuration is enforced via the execution module 230 and logged into the database 204.

In an embodiment, the routing module 226 is configured to determine at least one navigation route for each of the plurality of vehicles 112a-112d based, at least in part, on a plurality of navigation parameters.

In an embodiment, the communication module 228 is configured to enable communication between the plurality of vehicles 112a-112d via a V2V communication network to exchange the determined navigation route. Herein, each of the plurality of vehicles 112a-112d is configured to traverse based on the determined navigation route. For example, vehicles may exchange assigned routes over a Cellular Vehicle-to-Everything (C-V2X) or a Dedicated Short-Range Communications (DSRC) mesh relay, verified through the execution module 230 (for example, the scroll command runtime engine). A vehicle designated as a lead unit (for example, a Military (MIL) node) can broadcast its computed or determined route and terrain assessment to nearby support vehicles (for example, EMS node or Commercial node (COMM)), allowing the other vehicles to synchronize path traversal while maintaining route integrity and convoy unity.

Further, the communication module 228 is configured to receive an override command associated with at least one vehicle among the plurality of vehicles 112a-112d from the remote computing system 118 via the V2V communication network. In an exemplary scenario, the override command can be part of a signed mission packet (.orx) transmitted through a dedicated relay channel (for example, C-V2X or DSRC meshrelay) from the remote computing system 118 and verified using the scroll command runtime engine.

In a non-limiting implementation, the execution module 230 is configured to determine whether the override command is to be executed by the at least one of the plurality of vehicles 112a-112d based, at least in part, on one or more emergency events. For instance, an EMS vehicle within the convoy 112 (tagged as the EMS using a scroll command-issued role certificate) can detect a critical reroute request in the override command due to a flood. In such a case, the routing module 226 dynamically generates alternative route options using live terrain intelligence/data (for example, from Artificial Intelligence (AI) terrain scoring layers like lidar and radar fusion). These generated route options are evaluated based on multiple risk factors including threat likelihood (e.g., road collapse detected by the lidar), terrain difficulty (e.g., steep slope identified via Global Navigation Satellite System (GNSS) and Inertial Measurement Unit(IMU)), and adherence to mission parameters (e.g., priority delivery zones for the EMS).

As used herein, the term “threat likelihood” refers to the estimated probability of encountering hostile entities, environmental hazards, or obstacles along a given route segment, based on prior mission logs, and onboard sensor fusion (for example, Lidar, radar, camera).

The term “terrain difficulty” refers to a quantified assessment of terrain characteristics, including but not limited to slope grade, surface type (e.g., gravel, asphalt, mud), obstacle density, and vehicular navigability, as determined by onboard terrain analysis systems (such as routing module 226 and the onboard sensors) and historical route traversal outcomes.

The term “mission parameters” refers to the set of operational constraints and objectives that guide route selection during convoy operations. The mission parameters can include fuel constraints, stealth requirements, travel time targets, delivery priority zones, vehicle role-specific paths, and override policies issued by the remote computing system 118 or embedded within a mission configuration file (a digitally signed .orx format file containing mission configuration data).

In an implementation, in response to the detection of one or more emergency events, the routing module 226 generates one or more route options based, at least in part, on the terrain data 220 and predefined mission parameters. Further, the routing module 226 is configured to analyze one or more risk factors associated with the terrain data 220. The risk factors include threat likelihood, terrain difficulty, and alignment with the predefined mission parameters. The routing module 226 is configured to rank the one or more route options based, at least in part, on the one or more risk factors.

For example, in a mission involving an emergency services (EMS) vehicle operating in a high-risk flood-prone zone, the routing module 226 can detect an emergency event such as obstruction due to rising water levels using terrain data 220 derived from fused LiDAR and radar inputs. The routing module 226 then generates multiple alternative route options (i.e. routes). Each route is evaluated against risk factors, including threat likelihood (e.g., probability of bridge collapse or further flooding), terrain difficulty (e.g., steep incline calculated via GNSS with IMU sensors), and alignment with the predefined mission parameters (e.g., urgency to reach a priority delivery zone defined in the mission configuration). The generated routes are then ranked in order of compliance, with the safest and most time-efficient route surfaced to the execution module 230 for final override and dispatch approval.

In one embodiment, the terrain data 220 can include input from the GNSS integrated with the IMU sensors, which together provide precise vehicle geolocation and heading information during GPS-compromised conditions. These combined GNSS and IMU readings feed into the routing module 226 (e.g., AI Terrain Model) to assess terrain complexity and inform navigation route scoring.

For example, in a mission scenario involving a multi-role convoy traversing a contested urban zone, the routing module 226 can detect a flash flood event via terrain overlays derived from real-time Synthetic Aperture Radar (SAR) and onboard Lidar data. In this case, the routing module 226 generates alternate route options that bypass the flooded segment, evaluates each option against threat intelligence from the scroll command threat map, and ranks them using risk metrics such as potential ambush zones, elevation change, and route exposure to open terrain. For example, the risk factors include, but are not limited to, threat likelihood (e.g., presence of known adversarial zones derived from threat overlays or real-time intelligence feeds), terrain difficulty (e.g., steep gradients detected via onboard LIDAR sensors, or unstable surfaces identified from fused GNSS with IMU data), and alignment with predefined mission parameters (e.g., ensuring that the selected route complies with assigned mission role, autonomy level, and delivery or operational constraints such as fuel efficiency or convoy cohesion).

For example, in a mission where an EMS vehicle (tagged as EMS using a scroll command-issued role certificate) must reach a medical relief site, the routing module 226 can prioritize a route that bypasses a flood-prone zone in favor of a longer but safer asphalt road with confirmed path clearance. In another example, for a MIL-tagged vehicle, the routing module 226 can select a low-visibility route with higher terrain difficulty but lower enemy detection risk, based on intelligence overlays received from external data feeds and mission flags embedded in the configuration data 218.

In a non-limiting example, the routing module 226 is configured to determine the one or more emergency events based, at least in part, on the navigation parameters, terrain data 220, and sensory data collected from the plurality of vehicles. In an embodiment, in response to determining the override command to be executed, the routing module 226 is configured to determine a modified navigation route for each of the plurality of vehicles based, at least in part, on the one or more emergency events. Further, the communication module 228 is configured to transmit the modified navigation route to the remote computing system 118. Herein, the remote computing system 118 broadcasts the modified navigation route to each of the plurality of vehicles 112a-112d, thereby enabling the plurality of vehicles to traverse based on the modified navigation route.

The term “Emergency event” refers to a real-time, abnormal, or potentially hazardous condition detected through autonomous sensing or external input that necessitates a deviation from the planned route or mission logic. This may include natural events (e.g., flooding, landslide), mechanical failures, cybersecurity breaches, or unanticipated threats detected via terrain analysis or sensor feedback (e.g., LiDAR, thermal imaging, GNSS + IMU anomalies).

For example, an EMS-designated vehicle may detect terrain instability using on-board LiDAR and accelerometer data (via the sensory module within the vehicle). This triggers the routing module 226 to classify the situation as an emergency event (e.g., road collapse risk). The execution module 230 then initiates recalculation of a modified navigation route for the entire convoy 112 based on current positioning data (via GNSS and IMU), terrain overlays, and mission constraints. The communication module 228 transmits this updated route to the remote computing system 118, which authenticates and rebroadcasts the approved modified route to the remaining vehicles (e.g., the vehicle 112a, the vehicle 112b, etc.).

Further, the execution module 230 is configured to log the modified navigation route along with a timestamp and a hash of the override command or the modified navigation route. It is to be noted that logs are stored in the database 204.

For example, when a remote computing system 118 (such as a mission command node) issues a signed override command instructing a convoy reroute due to a detected threat (e.g., bridge collapse ahead), the execution module 230 verifies and executes the command, modifies the navigation route accordingly via the routing module 226, and logs the newly computed route along with a digital signature-based hash and current system time. This log entry is recorded in the database 204 to support traceability, accountability, and mission replay validation.

In an embodiment, the execution module 230 determines whether the autonomy level of each vehicle meets a minimum override execution threshold to execute the override command. Further, the execution module 230 regulates operational parameters of each vehicle based, at least in part, on the autonomy level of the vehicle.

The term “override execution threshold” refers to the minimum autonomy or security level a vehicle must meet to accept and act upon an override command. This threshold ensures that only capable and authenticated vehicles execute sensitive instructions, preserving operational integrity during mission-critical scenarios.

The term “autonomy level” refers to the classification of a vehicle’s capability to perform navigation and control tasks independently, ranging from fully autonomous (capable of executing commands without human input) to semi-autonomous or remotely operated (requiring human oversight or input for certain tasks).

For instance, if a convoy includes both fully autonomous vehicles (equipped with the autonomous navigation module 112a) and semi-autonomous vehicles (with partial remote control capability), the execution module 230 first verifies whether each vehicle’s autonomy level satisfies the minimum threshold to safely perform an emergency reroute. Vehicles that meet the threshold automatically execute the override command to change their navigation route, while those below the threshold may require manual intervention or additional remote commands. Additionally, the execution module 230 adjusts speed, sensor sensitivity, or communication frequency for each vehicle in accordance with its autonomy capabilities to ensure safe and effective operation during the override.

In some embodiments, the system 200 may be referred to as ORODRIVE™ that may provide an integrated convoy autonomy and override command framework. The system 200 may include one or more internal modules, such as a runtime enforcement engine (e.g.,ScrollCommand™), a logging component configured to capture SHA-authenticated command events (e.g.,Snap+Log™), a secure human–machine interface (e.g., Vault Terminal™), and a control logic module governing authorized override execution through a sovereign trust chain (e.g., SOVRAN™). The above-mentioned modules may operate in coordination to provide secure override capability, cryptographically verifiable logging, and decentralized command execution. The foregoing designations are proprietary identifiers used in development and are provided herein for purposes of clarity and system mapping. Their inclusion shall not be construed as limiting the scope of the present disclosure.

In certain embodiments, the system 200 may be assigned to D3 Dynasty Holdings Inc. and governed under a framework referred to as the T-97 Legacy Instrument. The T-97 Legacy Instrument may serve as a holding structure for intellectual property and derivative works associated with the system 200, including commercial implementations that may be licensed under a framework designated as REEDS™ (Resilient Enterprise Execution & Documentation System).

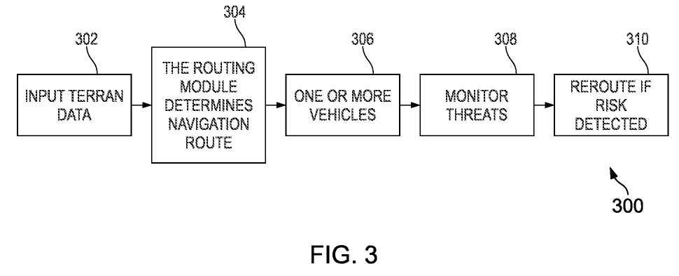

FIG. 3 illustrates a flow diagram representing routing decision logic performed by a routing module within the system architecture 100, in accordance with an embodiment of the present disclosure.

The process begins at operation 302, where the terrain data 302 as input is collected. The input terrain data 302 (hereinafter referred to as terrain data 302) can include road network graphs, elevation data, obstacles, and environmental overlays (e.g., weather conditions, flood zones, debris fields), and threat maps derived from external intelligence sources or onboard sensor fusion. For instance, the terrain data 302 can be sourced from onboard sensors, satellite imagery, or external databases, and serves as the foundational input for route determination.

At operation 304, the routing module 226 processes the input terrain data 302 along with predefined mission parameters to determine one or more navigation routes. The routing module 226 evaluates possible paths considering factors such as terrain difficulty, potential threats, and alignment with mission objectives. This step is critical for selecting routes that balance efficiency and safety for the vehicle(s).

Once routes are determined, at operation 306, one or more vehicles (e.g., the plurality of vehicles 112a-112d) are assigned or identified to follow the determined navigation route. The one or more vehicles could be autonomous or semi-autonomous platforms equipped with navigation and communication systems that allow them to receive and execute route instructions.

At block 308, the system 200 continuously monitors threats along the determined navigation route. In a non-limiting implementation, threat monitoring involves collecting sensory data from the plurality of vehicles 112a-112d and external sources to detect risks such as enemy activity, environmental hazards, or unexpected terrain changes. This real-time monitoring is essential for proactive risk management during mission execution.

Finally, at operation 310, if any risks or threats are detected, the system 200 triggers a reroute operation to dynamically adjust the determined navigation route. The routing module 226 generates alternative paths that avoid the identified threats while still meeting mission parameters. This ensures that one or more vehicles can continue their mission with minimized risk, maintaining operational safety and effectiveness.

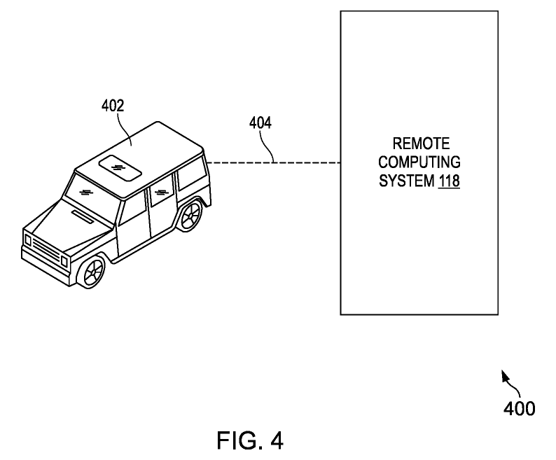

FIG. 4 illustrates an encrypted override communication process between a convoy vehicle and a remote computing system 118, in accordance with an embodiment of the present disclosure. The system architecture 100 enables secure, authenticated command propagation from a central control authority, such as the remote computing system 118 to the plurality of vehicles 112a-112d in the convoy 112, particularly during mission-critical or emergency scenarios requiring dynamic rerouting or role reassignment.

The architecture 400 depicted in FIG. 4 includes a vehicle 402 and the remote computing system 118, communicatively coupled via a secure communication link 404. The vehicle 402 corresponds to any one of the authenticated vehicles 112a-112d of the system 100 (as shown in FIG. 1). The secure communication link 404 enables transmission of digitally signed override commands (such as an override command) from the remote computing system 118 to the vehicle 402 in real-time or near real-time operational scenarios.

In an embodiment, the remote computing system 118 functions as a centralized command authority or a mission control node authorized to issue override instructions. These override commands can be transmitted as digitally signed mission packets (e.g.,scroll command override packets). The override commands can include modifications such as alternate routes, emergency stop signals, or changes in vehicle role or behavior, depending on mission needs and real-time sensor inputs.

The vehicle 402 is equipped with an onboard communication module (e.g., the communication module 228), which receives the override command over the secure communication link 404 from the remote computing system 118. The received command is authenticated using a hardware-based security component, such as a Trusted Platform Module (TPM) or Hardware Security Module (HSM) embedded within the vehicle 402.

The term “secure communication link” refers to an encrypted data channel between a convoy vehicle and the remote computing system 118. This channel ensures the confidentiality, authenticity, and integrity of transmitted messages, such as override commands or telemetry updates. The secure communication link may be implemented using protocols such as C-V2X, DSRC, or proprietary military-grade encryption technologies.

In an embodiment, an encrypted override command is transmitted from the remote computing system 118 using a digitally signed mission packet. The packet includes, but is not limited to, a command identifier, target vehicle role, routing directives, execution priority level, and a cryptographic signature. Upon receipt of the encrypted override command, the communication module 228 forwards the digitally signed mission packet to the TPM or HSM for validation.

Upon successful verification, the override command is passed to the execution module 230, which determines whether the override command should be executed based on predefined autonomy levels, operational constraints, or detected emergency events. If eligible, the override command is routed to appropriate subsystems (e.g., the routing module 226) for contextual execution. This encrypted communication process ensures secure, role-compliant, and auditable override execution even in partially connected or adversarial environments.

For example, in a high-risk terrain scenario where vehicle 402 (e.g., a lead vehicle tagged as MIL or EMS) receives intelligence about an obstructed or dangerous path, the remote computing system 118 may issue a reroute command. This command is encapsulated in a signed override file and delivered over the communication link 404. After signature validation by the vehicle’s security stack, the command is processed by the routing module 226 to generate an alternate navigation route using terrain data, navigation parameters, and mission constraints (e.g., stealth requirement, delivery window). The new route is then logged by the execution module 230, along with a hash of the command and a secure timestamp, into the onboard or distributed database (e.g., database 204).

It is to be noted that although FIG. 4 depicts a single vehicle 402, in practice, such override commands can be broadcast to multiple authenticated vehicles simultaneously using a mesh or multicast communication scheme, such as Cellular Vehicle-to-Everything (C-V2X) or Dedicated Short-Range Communications (DSRC). The secure communication link 404 may represent any encrypted wireless channel, tactical relay network, or hybrid infrastructure, depending on the deployment scenario.

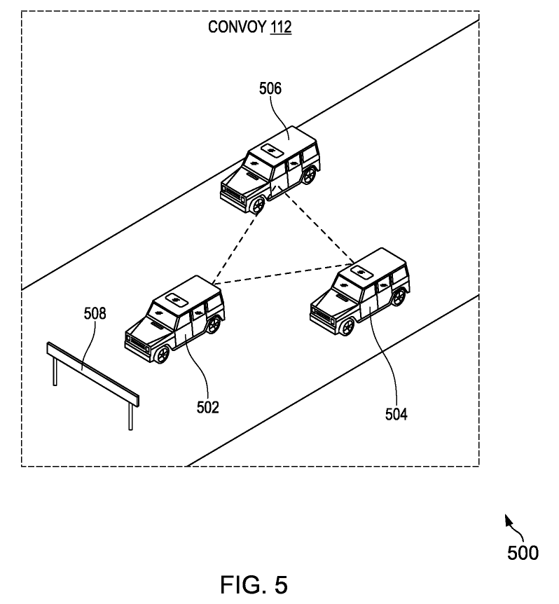

FIG. 5 illustrates an architecture of a convoy coordination system with inter-vehicle communication and obstacle detection, in accordance with an embodiment of the present disclosure.

The architecture 500 includes a plurality of vehicles 502, 504, and 506 arranged as part of the convoy 112, operating in a coordinated manner to achieve shared mission objectives under the control of the system 110 described in FIGS. 1 and 2.

Each of the vehicles 502, 504, and 506 represents authenticated convoy units equipped with onboard modules such as the routing module 226, communication module 228, and execution module 230. These modules facilitate synchronized navigation, threat monitoring, and command execution across the convoy 112. The vehicles communicate with each other over secure vehicle-to-vehicle (V2V) links, enabling dynamic coordination and role-specific task sharing based on terrain complexity, threat levels, or mission priorities.

The inter-vehicle communication allows for real-time data exchange relating to navigation parameters, detected anomalies, and updated route directives. For instance, the vehicle 502 acts as a lead vehicle and shares situational awareness data with the following vehicles 504 and 506. Such communications can be carried out using protocols such as Dedicated Short-Range Communications (DSRC) or Cellular Vehicle-to-Everything (C-V2X), ensuring low-latency and authenticated message delivery.

For example, an obstacle 508 is depicted along the planned navigation route, symbolizing a potential hazard such as a physical barricade (as shown in FIG. 5), terrain anomaly, or detected threat. The presence of such an obstacle 508 can trigger an emergency event as defined in the system 200. Upon detection of the obstacle 508, the routing module 226 (e.g., within the vehicle 502) initiates re-evaluation of the current route using stored terrain data 220, sensor inputs, and predefined mission parameters. The rerouting decision is then propagated across the convoy 112 through the communication module 228, and execution is handled by the execution module 230 within each vehicle.

For example, if the vehicle 502 detects the obstacle 508 using onboard sensors or receives hazard data from the remote computing system 118, it may broadcast a reroute recommendation or an override command to the vehicles 504 and 506. The response across the convoy 112 is coordinated to maintain mission continuity while adhering to safety and security policies, with each vehicle evaluating its autonomy level and operational constraints before executing the command.

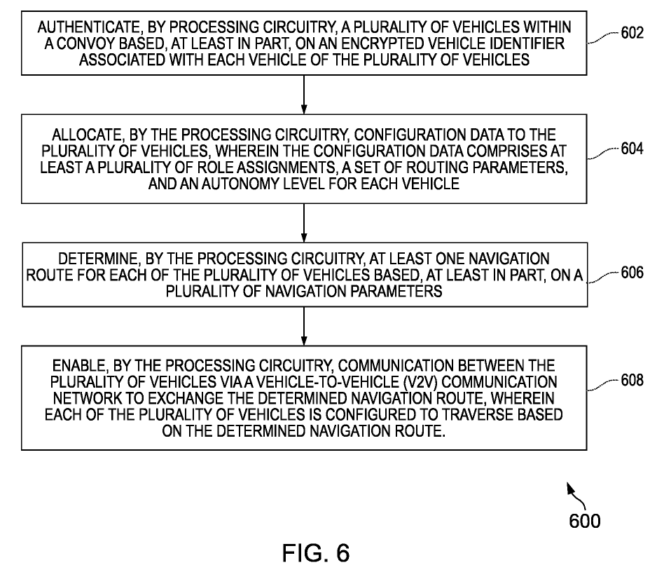

FIG. 6 illustratesa process flow diagram depicting a method 600 for autonomous convoy routing and route management, in accordance with an embodiment of the present disclosure. The method 600 depicted in the flow diagram may be executed by, for example, the system 200. The sequence of operations of the method 600 may not necessarily be executed in the same order as they are presented. Further, one or more operations may be grouped and performed in the form of a single step, or one operation may have several sub-steps that may be performed in parallel or in a sequential manner. Operations of the method 600, and combinations of operations in the method 600, may be implemented by, for example, hardware, firmware, a processor, circuitry, and/or a different device associated with the execution of software that includes one or more computer program instructions. The plurality of operations is depicted in the process flow of the method 600. The process flow starts at operation 602.

At operation 602, the method 600 includes authenticating, by a processor, a plurality of vehicles within a convoy 112 based, at least in part, on an encrypted vehicle identifier associated with each vehicle of the plurality of vehicles.

At operation 604, the method 600 includes allocating, by the processor, configuration data 218 to the plurality of vehicles upon successful authentication. Herein, the configuration data 218 includes at least a plurality of role assignments, a set of routing parameters, and an autonomy level for each vehicle.

At operation 606, the method 600 includes determining, by the processor, at least one navigation route for each of the plurality of vehicles based, at least in part, on a plurality of navigation parameters.

At operation 608, the method 600 includes enabling, by the processor, communication between the plurality of vehicles via a vehicle-to-vehicle (V2V) communication network to exchange the determined navigation route.Herein, each of the plurality of vehicles is configured to traverse based on the determined navigation route.

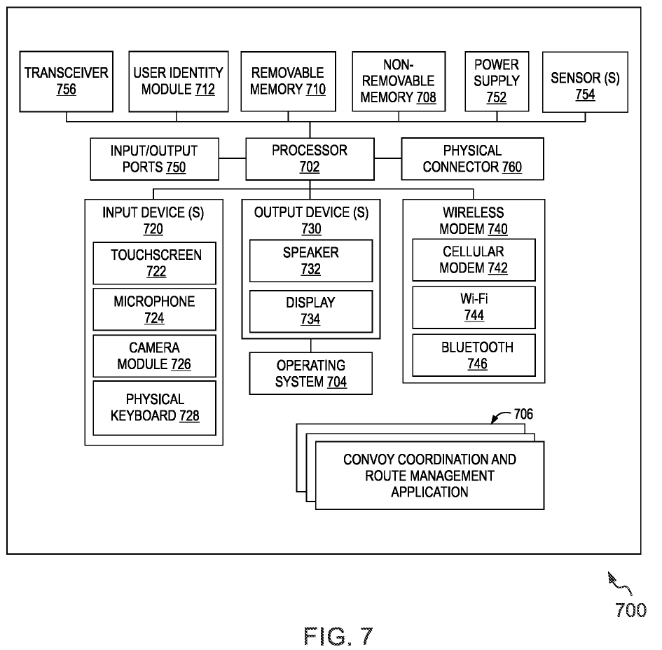

FIG. 7 shows a simplified block diagram of a remote computing system 700, for example a mobile phone or a desktop computer capable of implementing the various embodiments of the present disclosure. For example, the remote computing system 700 may correspond to the remote computing systems 118 of FIG. 1. The remote computing system 700 is depicted to include one or more applications such as a convoy coordination and route management application 706 managed and hosted by the system 200. The convoy coordination and route management application 706 can be an instance of an application downloaded from the system 200 or a third-party server. The portfolio market trend tracking application 706 is capable of communicating with the system 200 for tracking a market trend and triggering trade operations by facilitating the generation of the market trend tracking component, which can be used to trigger the trade operations.

It should be understood that the remote computing system 700, as illustrated and hereinafter described, is merely illustrative of one type of device and should not be taken to limit the scope of the embodiments. As such, it should be appreciated that at least some of the components described below in connection with the remote computing system 700 may be optional, and thus in an example embodiment may include more, less, or different components than those described in connection with the example embodiment of the FIG. 7. As such, among other examples, the remote computing system 700 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated remote computing system 700 includes a controller or a processor 702 (e.g., a signal processor, microprocessor, ASIC, or other control and processing logic circuitry) for performing such tasks as signal coding, data processing, image processing, input/output processing, power control, and/or other functions. An operating system 704 controls the allocation and usage of the components of the remote computing system 700 and supports one or more application programs, such as the portfolio market trend tracking application 706, that implements one or more of the innovative features described herein. In addition to the portfolio market trend tracking application 706, the applications may include common mobile computing applications (e.g., telephony applications, email applications, calendars, contact managers, web browsers, messaging applications) or any other computing application.

The illustrated remote computing system 700 includes one or more memory components, for example, a non-removable memory 708 and/or a removable memory 710. The non-removable memory 708 and/or the removable memory 710 may be collectively known as a database in an embodiment. The non-removable memory 708 can include RAM, ROM, flash memory, a hard disk, or other well-known memory storage technologies. The removable memory 710 can include flash memory, smart cards, or a Subscriber Identity Module (SIM). The one or more memory components can be used for storing data and/or code for running the operating system 704 and the portfolio market trend tracking application 706. The remote computing system 700 may further include a user identity module (UIM) 712. The UIM 712 may be a memory device having a processor built in. The UIM 712 may include, for example, a subscriber identity module (SIM), a universal integrated circuit card (UICC), a universal subscriber identity module (USIM), a removable user identity module (R-UIM), or any other smart card. The UIM 712 typically stores information elements related to a mobile subscriber. The UIM 712 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA7000, wideband CDMA (WCDMA) and time division-synchronous CDMA (TD-SCDMA), or with fourth-generation (4G) wireless communication protocols such as LTE (Long-Term Evolution).

The remote computing system 700 can support one or more input devices 720 and one or more output devices 730. Examples of the input devices 720 may include, but are not limited to, a touch screen / a display screen 722 (e.g., capable of capturing finger tap inputs, finger gesture inputs, multi-finger tap inputs, multi-finger gesture inputs, or keystroke inputs from a virtual keyboard or keypad), a microphone 724 (e.g., capable of capturing voice input), a camera module 726 (e.g., capable of capturing still picture images and/or video images) and a physical keyboard 728. Examples of the output devices 730 may include, but are not limited to, a speaker 732 and a display 734. Other possible output devices can include piezoelectric or other haptic output devices. Some devices can serve more than one input/output function. For example, the touch screen 722 and the display 734 can be combined into a single input/output device.

A wireless modem 740 can be coupled to one or more antennas (not shown in FIG. 7) and can support two-way communications between the processor 702 and external devices, as is well understood in the art. The wireless modem 740 is shown generically and can include, for example, a cellular modem 742 for communicating at long range with the mobile communication network, a Wi-Fi compatible modem 744 for communicating at short range with an external Bluetooth-equipped device, or a local wireless data network or router, and/or a Bluetooth-compatible modem 746. The wireless modem 740 is typically configured for communication with one or more cellular networks, such as a GSM network for data and voice communications within a single cellular network, between cellular networks, or between the remote computing system 700 and a public switched telephone network (PSTN).

The remote computing system 700 can further include one or more input/output ports 750, a power supply 752, one or more sensors 754 for example, an accelerometer, a gyroscope, a compass, or an infrared proximity sensor for detecting the orientation or motion of the remote computing system 700 and biometric sensors for scanning biometric identity of an authorized user, a transceiver 756 (for wirelessly transmitting analog or digital signals) and/or a physical connector 760, which can be a USB port, an IEEE 994 (FireWire) port, and/or a RS-232 port. The illustrated components are not required or all-inclusive, as any of the components shown can be deleted, and other components can be added.

The disclosed method with reference to FIG. 6, or one or more operations of the method 600 may be implemented using software including computer-executable instructions stored on one or more computer-readable media (e.g., non-transitory computer-readable media, such as one or more optical media discs, volatile memory components (e.g., DRAM or SRAM)), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the disclosure has been described with reference to specific exemplary embodiments, it is noted that various modifications and changes may be made to these embodiments without departing from the broad spirit and scope of the presentdisclosure. For example, the various operations, blocks, etc., described herein may be enabled and operated using hardware circuitry (for example, complementary metal oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the system 200 and its various components such as the computer system 202 and the database 204 may be enabled using software and/or using transistors, logic gates, and electrical circuits (for example, integrated circuit circuitry such as ASIC circuitry). Various embodiments of the disclosure may include one or more computer programs stored or otherwise embodied on a computer-readable medium, wherein the computer programs are configured to cause a processor or the computer to perform one or more operations. A computer-readable medium storing, embodying, or encoded with a computer program, or similar language may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. Acomputer-implemented method, comprising:
authenticating, by a processor, a plurality of vehicles within a convoy based, at least in part, on an encrypted vehicle identifier associated with each vehicle of the plurality of vehicles;
upon successful authentication, allocating, by the processor, configuration data to the plurality of vehicles, wherein the configuration data includes at least a plurality of role assignments, a set of routing parameters, and an autonomy level for each vehicle;
determining, by the processor, at least one navigation route for each of the plurality of vehicles based, at least in part, on a plurality of navigation parameters;and
enabling, by the processor, communication between the plurality of vehicles via a vehicle-to-vehicle (V2V) communication network to exchange the determined navigation route, wherein each of the plurality of vehicles is configured to traverse based on the determined navigation route.

2. The computer-implemented method as claimed in claim 1, further comprising:
receiving, by the processor, an override command associated with at least one vehicle among the plurality of vehicles from a remote computing system via the V2V communication network; and
determining, by the processor, whether the override command is to be executed by the at least one of the plurality of vehicles based, at least in part, on one or more emergency events.

3. The computer-implemented method as claimed in claim 2, further comprising:
in response to determining the override command to be executed, determining, by the processor, a modified navigation route for each of the plurality of vehicles based, at least in part, on the one or more emergency events;
transmitting, by the processor, the modified navigation route to the remote computing system, wherein the remote computing system broadcasts the modified navigation route to each of the plurality of vehicles, thereby enabling the plurality of vehicles to traverse based on the modified navigation route; and
logging, by the processor, the modified navigation route along with a timestamp and a hash of the override command or the modified navigation route.

4. The computer-implemented method as claimed in claim 2, further comprising:
determining, by the processor, the one or more emergency events based, at least in part, on the navigation parameters, terrain data, and sensory data collected from the plurality of vehicles.

5. The computer-implemented method as claimed in claim 1,further comprising:
determining, by the processor, whether the autonomy level of each vehicle meets a minimum override execution threshold to execute the override command; and
regulating, by the processor, operational parameters of each vehicle based, at least in part, on the autonomy level of the vehicle.

6. The computer-implemented method as claimed in claim 1,wherein authenticating the plurality of vehicles further comprises validating, by the processor, a digital certificate associated with each vehicle of the plurality of vehicles using cryptographic signature verification.

7. The computer-implemented method as claimed in claim 2, further comprising:
in response to detecting the one or more emergency events, generating, by the processor, one or more route options based, at least in part, on the terrain data and predefined mission parameters;
analyzing, by the processor, one or more risk factors associated with the terrain data, the risk factors comprising threat likelihood, terrain difficulty, and alignment with the predefined mission parameters; and
ranking, by the processor, the one or more route options based, at least in part, on the one or more risk factors.

8. A system, comprising:
a memory unit comprising machine-readable instructions; and
a processor operably connected to the memory unit, the processor configured to execute the machine-readable instructions, the machine-readable instructions when executed by the processor, causes the system to:
authenticate a plurality of vehicles within a convoy based, at least in part, on an encrypted vehicle identifier associated with each vehicle of the plurality of vehicles;
upon successful authentication, allocate configuration data to the plurality of vehicles, wherein the configuration data comprises at least a plurality of role assignments, a set of routing parameters, and an autonomy level for each vehicle;
determine at least one navigation route for each of the plurality of vehicles based, at least in part, on a plurality of navigation parameters;and
enable communication between the plurality of vehicles via a vehicle-to-vehicle (V2V) communication network to exchange the determined navigation route, wherein each of the plurality of vehicles is configured to traverse based on the determined navigation route.

9. The system as claimed in claim 8, wherein the system is further caused to:
receive an override command associated with at least one vehicle among the plurality of vehicles from a remote computing system via the V2V communication network;and
determine whether the override command is to be executed by the at least one of the plurality of vehicles based, at least in part, on one or more emergency events.

10. The system as claimed in claim 9, wherein the system is further caused to:
in response to determining the override command to be executed, determine a modified navigation route for each of the plurality of vehicles based, at least in part, on the one or more emergency events;
transmit the modified navigation route to the remote computing system, wherein the remote computing system broadcasts the modified navigation route to each of the plurality of vehicles, thereby enabling the plurality of vehicles to traverse based on the modified navigation route; and
log the modified navigation route along with a timestamp and a hash of the override command or the modified navigation route.

11. The system as claimed in claim 9, wherein the system is further caused to:
determine the one or more emergency events based, at least in part, on the navigation parameters, terrain data, and sensory data collected from the plurality of vehicles.

12. The system as claimed in claim 8,wherein the system is further caused to:
determine whether the autonomy level of each vehicle meets a minimum override execution threshold to execute the override command; and
regulate operational parameters of each vehicle based, at least in part, on the autonomy level of the vehicle.

13. The system as claimed in claim 8, wherein to authenticate the plurality of vehicles further comprises validate a digital certificate associated with each vehicle of the plurality of vehicles using cryptographic signature verification.

14. The system as claimed in claim 9, wherein the system is further caused to:
in response to detecting the one or more emergency events, generate one or more route options based, at least in part, on the terrain data and predefined mission parameters;
analyze one or more risk factors associated with the terrain data, the risk factors comprising threat likelihood, terrain difficulty, and alignment with the predefined mission parameters; and
rank the one or more route options based, at least in part, on the one or more risk factors.

15. A non-transitory computer-readable storage medium including computer-executable instructions that, when executed by at least a processor of a system, cause the system to perform a method comprising:
authenticating a plurality of vehicles within a convoy based, at least in part, on an encrypted vehicle identifier associated with each vehicle of the plurality of vehicles;
upon successful authentication, allocating configuration data to the plurality of vehicles, wherein the configuration data comprises at least a plurality of role assignments, a set of routing parameters, and an autonomy level for each vehicle;
determining at least one navigation route for each of the plurality of vehicles based, at least in part, on a plurality of navigation parameters;and
enabling communication between the plurality of vehicles via a vehicle-to-vehicle (V2V) communication network to exchange the determined navigation route, wherein each of the plurality of vehicles is configured to traverse based on the determined navigation route.

16. The non-transitory computer-readable storage medium as claimed in claim 15, further comprising:
receiving an override command associated with at least one vehicle among the plurality of vehicles from a remote computing system via the V2V communication network;and
determining whether the override command is to be executed by the at least one of the plurality of vehicles based, at least in part, on one or more emergency events.

17. The non-transitory computer-readable storage medium as claimed in claim 15, further comprising:
in response to determining the override command to be executed, determining a modified navigation route for each of the plurality of vehicles based, at least in part, on the one or more emergency events;
transmitting the modified navigation route to the remote computing system, wherein the remote computing system broadcasts the modified navigation route to each of the plurality of vehicles, thereby enabling the plurality of vehicles to traverse based on the modified navigation route; and
logging the modified navigation route along with a timestamp and a hash of the override command or the modified navigation route.

18. The non-transitory computer-readable storage medium as claimed in claim 16, further comprising:
determining the one or more emergency events based, at least in part, on the navigation parameters, terrain data, and sensory data collected from the plurality of vehicles.

19. The non-transitory computer-readable storage medium as claimed in claim 15, further comprising:
determining whether the autonomy level of each vehicle meets a minimum override execution threshold to execute the override command; and
regulating operational parameters of each vehicle based, at least in part, on the autonomy level of the vehicle.

20. The non-transitory computer-readable storage medium as claimed in claim 15, wherein authenticating the plurality of vehicles further comprises validating a digital certificate associated with each vehicle of the plurality of vehicles using cryptographic signature verification.
